(19) United States
(12) Patent Application Publication
(10) Pub. No.: US 2012/0219054 A1
(43) Pub. Date: Aug. 30, 2012

(54) MULTI-PASS VIDEO ENCODER AND METHODS FOR USE THEREWITH

(75) Inventors: Sally Jean Daub, Toronto (CA); Xinghai (Billy) Li, North York (CA); Ying Li, Richmond Hill (CA); Xu Gang (Wilf) Zhao, Maple (CA)

(73) Assignee: VIXS SYSTEMS, INC., Toronto (CA)

(21) Appl. No.: 13/034,392

(22) Filed: Feb. 24, 2011

(51) Int. Cl. H04N 7/26

(52) U.S. Cl. 375/240.03; 375/240.02; 375/E07.139

(57) ABSTRACT

A multi-pass video encoder includes a video encoding module that encodes a video signal based on an initial configuration data set to generate an initial processed video signal and an initial output data set. An application coding control module generates the initial configuration data set and generates a first updated configuration data set based on both the initial processed video signal and the initial output data set. The video encoding module further encodes the video signal based on the first updated configuration data set to generate a first updated processed video signal and a first updated output data set.

### CROSS REFERENCE TO RELATED PATENTS

Not Applicable

### TECHNICAL FIELD OF THE INVENTION

The present invention relates to encoding used in devices such as video encoders/decoders.

### DESCRIPTION OF RELATED ART

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Standards have been promulgated for many encoding methods including the H.264 standard that is also referred to as MPEG-4, part 10 or Advanced Video Coding, (AVC). While this standard sets forth many powerful techniques, further improvements are possible to improve the performance and speed of implementation of such methods. The video signal encoded by these encoding methods must be similarly decoded for playback on most video display devices.

Efficient and fast encoding and decoding of video signals is important to the implementation of many video devices, particularly video devices that are destined for home use. Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of various video devices in accordance with embodiments of the present invention.

FIG. 4 presents a block diagram representation of a video device in accordance with an embodiment of the present invention.

FIG. 5 presents a block diagram representation of a video encoder/decoder 102 in accordance with an embodiment of the present invention.

FIG. 6 presents a block flow diagram of a video encoding operation in accordance with an embodiment of the present invention.

FIG. 7 presents a block flow diagram of a video decoding operation in accordance with an embodiment of the present invention.

FIG. 8 presents a block diagram representation of a video encoder in accordance with an embodiment of the present invention.

FIG. 9 presents a block diagram representation of an application coding control module 225 in accordance with an embodiment of the present invention.

FIG. 10 presents a graphical representation of processed video signal 306 in accordance with an embodiment of the present invention.

FIG. 11 presents a block diagram representation of a video distribution system 375 in accordance with an embodiment of the present invention.

FIG. 12 presents a block diagram representation of a video storage system 179 in accordance with an embodiment of the present invention.

FIG. 13 presents a flowchart representation of a method in accordance with an embodiment of the present invention.

FIG. 14 presents a flowchart representation of a method in accordance with an embodiment of the present invention.

### DETAILED DESCRIPTION OF THE INVENTION INCLUDING THE PRESENTLY PREFERRED EMBODIMENTS

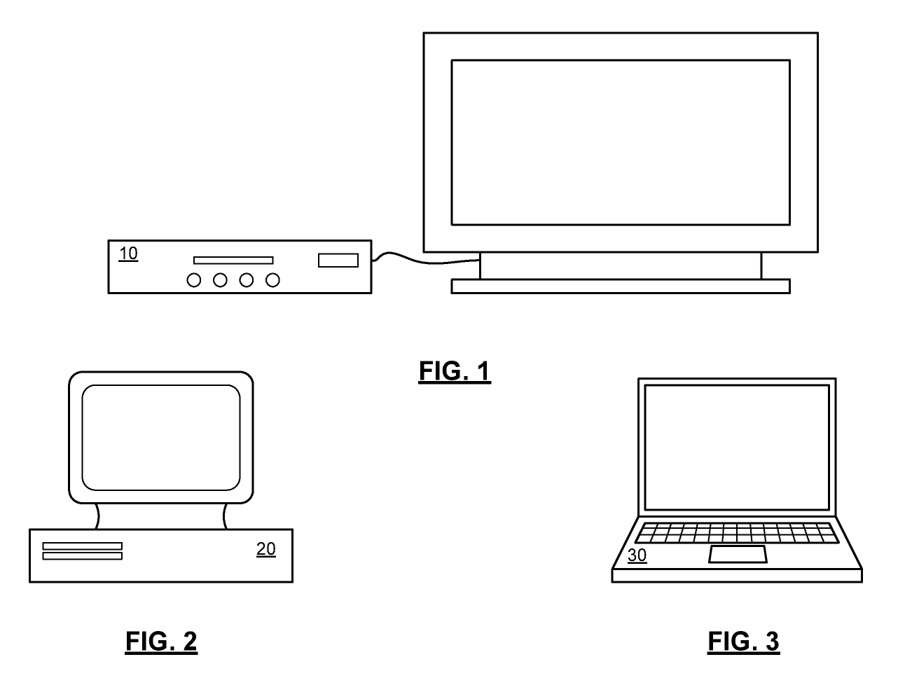

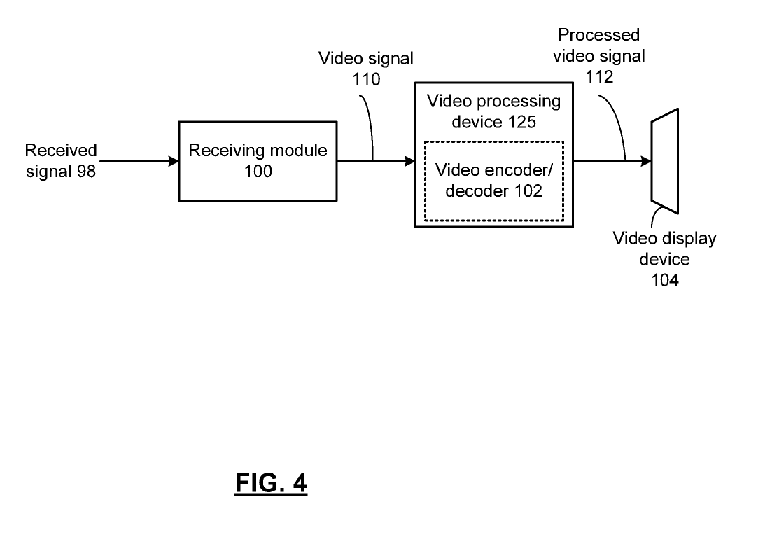

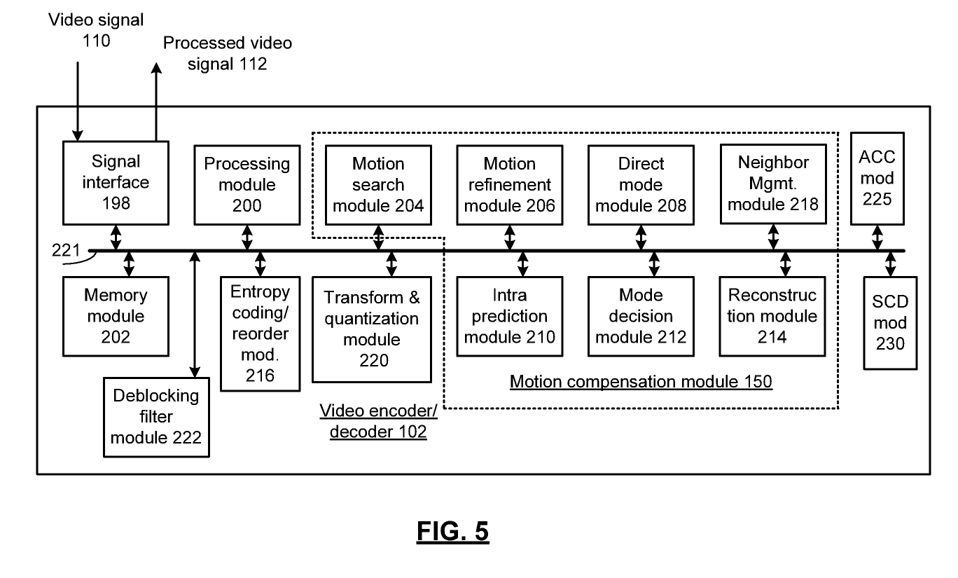

FIGS. 1-3 present pictorial diagram representations of various video devices in accordance with embodiments of the present invention. In particular, set top box 10 with built-in digital video recorder functionality or a stand alone digital video recorder, computer 20 and portable computer 30 illustrate electronic devices that incorporate a video device 125 that includes one or more features or functions of the present invention. While these particular devices are illustrated, video processing device 125 includes any device that is capable of encoding, decoding and/or transcoding video content in accordance with the methods and systems described in conjunction with FIGS. 4-14 and the appended claims.

FIG. 4 presents a block diagram representation of a video device in accordance with an embodiment of the present invention. In particular, this video device includes a receiving module 100, such as a television receiver, cable television receiver, satellite broadcast receiver, broadband modem, 3G transceiver or other information receiver or transceiver that is capable of receiving a received signal 98 and extracting one or more video signals 110 via time division demultiplexing, frequency division demultiplexing or other demultiplexing technique. Video processing device 125 includes video encoder/decoder 102 and is coupled to the receiving module 100 to encode, decode or transcode the video signal for storage, editing, and/or playback in a format corresponding to video display device 104.

In an embodiment of the present invention, the received signal 98 is a broadcast video signal, such as a television signal, high definition television signal, enhanced definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include an analog video signal that is formatted in any of a number of video formats including National Television Systems Committee (NTSC), Phase Alternating Line (PAL) or Sequentiel Couleur Avec Memoire (SECAM). Processed video signal 112 can include a digital video signal complying with a digital video codec standard such as H.264, MPEG-4 Part 10 Advanced Video Coding (AVC) or another digital format such as a Motion Picture Experts Group (MPEG) format (such as MPEG1, MPEG2 or MPEG4), QuickTime format, Real Media format, Windows Media Video (WMV) or Audio Video Interleave (AVI), etc.

Video display devices 104 can include a television, monitor, computer, handheld device or other video display device that creates an optical image stream either directly or indirectly, such as by projection, based on decoding the processed video signal 112 either as a streaming video signal or by playback of a stored digital video file.

FIG. 5 presents a block diagram representation of a video encoder/decoder 102 in accordance with an embodiment of the present invention. In particular, video encoder/decoder 102 can be a video codec that operates in accordance with many of the functions and features of the H.264 standard, the MPEG-4 standard, VC-1 (SMPTE standard 421M) or other standard, to generate processed video signal 112 by encoding, decoding or transcoding video signal 110. Video signal 110 is optionally formatted by signal interface 198 for encoding, decoding or transcoding.

The video encoder/decoder 102 includes a processing module 200 that can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 200, and memory module 202 are coupled, via bus 221, to the signal interface 198 and a plurality of other modules, such as motion search module 204, motion refinement module 206, direct mode module 208, intra-prediction module 210, mode decision module 212, reconstruction module 214, entropy coding/reorder module 216, neighbor management module 218, forward transform and quantization module 220, deblocking filter module 222, application coding and control module 225 and scene detection module 230. In an embodiment of the present invention, the modules of video encoder/decoder 102 can be implemented via an XCODE processing device sold by VIXS Systems, Inc along with software or firmware. Alternatively, one or more of these modules can be implemented using other hardware, such as another processor or a hardware engine that includes a state machine, analog circuitry, digital circuitry, and/or logic circuitry, and that operates either independently or under the control and/or direction of processing module 200 or one or more of the other modules, depending on the particular implementation. It should also be noted that the software implementations of the present invention can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present invention.

Video encoder/decoder 102 can operate in various modes of operation that include an encoding mode and a decoding mode that is set by the value of a mode selection signal that may be a user defined parameter, user input, register value, memory value or other signal. In addition, in video encoder/decoder 102, the particular standard used by the encoding or decoding mode to encode or decode the input signal can be determined by a standard selection signal that also may be a user defined parameter, user input, register value, memory value or other signal. In an embodiment of the present invention, the operation of the encoding mode utilizes a plurality of modules that each perform a specific encoding function. The operation of decoding also utilizes at least one of these plurality of modules to perform a similar function in decoding. In this fashion, modules such as the motion refinement module 206 and more particularly an interpolation filter used therein, and intra-prediction module 210, can be used in both the encoding and decoding process to save on architectural real estate when video encoder/decoder 102 is implemented on an integrated circuit or to achieve other efficiencies. In addition, some or all of the components of the direct mode module 208, mode decision module 212, reconstruction module 214, transformation and quantization module 220, deblocking filter module 222 or other function specific modules can be used in both the encoding and decoding process for similar purposes.

Motion compensation module 150 includes a motion search module 204 that processes pictures from the video signal 110 based on a segmentation into macroblocks of pixel values, such as of 16 pixels by 16 pixels size, from the columns and rows of a frame and/or field of the video signal 110. In an embodiment of the present invention, the motion search module determines, for each macroblock or macroblock pair of a field and/or frame of the video signal one or more motion vectors that represents the displacement of the macroblock (or subblock) from a reference frame or reference field of the video signal to a current frame or field. In operation, the motion search module operates within a search range to locate a macroblock (or subblock) in the current frame or field to an integer pixel level accuracy such as to a resolution of 1-pixel. Candidate locations are evaluated based on a cost formulation to determine the location and corresponding motion vector that have a most favorable (such as lowest) cost.

In an embodiment of the present invention, a cost formulation is based on the Sum of Absolute Difference (SAD) between the reference macroblock and candidate macroblock pixel values and a weighted rate term that represents the number of bits required to be spent on coding the difference between the candidate motion vector and either a predicted motion vector (PMV) that is based on the neighboring macroblock to the right of the current macroblock and on motion vectors from neighboring current macroblocks of a prior row of the video signal or an estimated predicted motion vector that is determined based on motion vectors from neighboring current macroblocks of a prior row of the video signal. In an embodiment of the present invention, the cost calculation avoids the use of neighboring subblocks within the current macroblock. In this fashion, motion search module 204 is able to operate on a macroblock to contemporaneously determine the motion search motion vector for each subblock of the macroblock.

A motion refinement module 206 generates a refined motion vector for each macroblock of the plurality of macroblocks, based on the motion search motion vector. In an embodiment of the present invention, the motion refinement module determines, for each macroblock or macroblock pair of a field and/or frame of the video signal 110, a refined motion vector that represents the displacement of the macroblock from a reference frame or reference field of the video signal to a current frame or field.

Based on the pixels and interpolated pixels, the motion refinement module 206 refines the location of the macroblock in the current frame or field to a greater pixel level accuracy such as to a resolution of ¼-pixel or other sub-pixel resolution. Candidate locations are also evaluated based on a cost formulation to determine the location and refined motion vector that have a most favorable (such as lowest) cost. As in the case with the motion search module, a cost formulation can be based on the Sum of Absolute Difference (SAD) between the reference macroblock and candidate macroblock pixel values and a weighted rate term that represents the number of bits required to be spent on coding the difference between the candidate motion vector and either a predicted motion vector (PMV) that is based on the neighboring macroblock to the right of the current macroblock and on motion vectors from neighboring current macroblocks of a prior row of the video signal or an estimated predicted motion vector that is determined based on motion vectors from neighboring current macroblocks of a prior row of the video signal. In an embodiment of the present invention, the cost calculation avoids the use of neighboring subblocks within the current macroblock. In this fashion, motion refinement module 206 is able to operate on a macroblock to contemporaneously determine the motion search motion vector for each subblock of the macroblock.

When estimated predicted motion vectors are used, the cost formulation avoids the use of motion vectors from the current row and both the motion search module 204 and the motion refinement module 206 can operate in parallel on an entire row of video signal 110, to contemporaneously determine the refined motion vector for each macroblock in the row.

A direct mode module 208 generates a direct mode motion vector for each macroblock, based on macroblocks that neighbor the macroblock. In an embodiment of the present invention, the direct mode module 208 operates to determine the direct mode motion vector and the cost associated with the direct mode motion vector based on the cost for candidate direct mode motion vectors for the B slices of video signal 110, such as in a fashion defined by the H.264 standard.

While the prior modules have focused on inter-prediction of the motion vector, intra-prediction module 210 generates a best intra prediction mode for each macroblock of the plurality of macroblocks. In an embodiment of the present invention, intra-prediction module 210 operates as defined by the H.264 standard, however, other intra-prediction techniques can likewise be employed. In particular, intra-prediction module 210 operates to evaluate a plurality of intra prediction modes such as a Intra-4×4 or Intra-16×16, which are luma prediction modes, chroma prediction (8×8) or other intra coding, based on motion vectors determined from neighboring macroblocks to determine the best intra prediction mode and the associated cost.

A mode decision module 212 determines a final macroblock cost for each macroblock of the plurality of macroblocks based on costs associated with the refined motion vector, the direct mode motion vector, and the best intra prediction mode, and in particular, the method that yields the most favorable (lowest) cost, or an otherwise acceptable cost. A reconstruction module 214 completes the motion compensation by generating residual luma and/or chroma pixel values for each macroblock of the plurality of macroblocks.

A forward transform and quantization module 220 of video encoder/decoder 102 generates processed video signal 112 by transforming coding and quantizing the residual pixel values into quantized transformed coefficients that can be further coded, such as by entropy coding in entropy coding module 216, filtered by de-blocking filter module 222. In an embodiment of the present invention, further formatting and/or buffering can optionally be performed by signal interface 198 and the processed video signal 112 can be represented as being output therefrom.

As discussed above, many of the modules of motion compensation module 150 operate based on motion vectors determined for neighboring macroblocks. Neighbor management module 218 generates and stores neighbor data for at least one macroblock of the plurality of macroblocks for retrieval by at least one of the motion search module 204, the motion refinement module 206, the direct mode module 208, intra-prediction module 210, entropy coding module 216 and deblocking filter module 222, when operating on at least one neighboring macroblock of the plurality of macroblocks. In an embodiment of the present invention, a data structure, such as a linked list, array or one or more registers are used to associate and store neighbor data for each macroblock in a buffer, cache, shared memory or other memory structure. Neighbor data includes motion vectors, reference indices, quantization parameters, coded-block patterns, macroblock types, intra/inter prediction module types neighboring pixel values and or other data from neighboring macroblocks and/or subblocks used to by one or more of the modules or procedures of the present invention to calculate results for a current macroblock. For example, in order to determine the predicated motion vector for the motion search module 204 and motion refinement module 206, both the motion vectors and reference index of neighbors are required. In addition to these data, the direct mode module 208 requires the motion vectors of the co-located macroblock of previous reference pictures. The deblocking filter module 222 operates according to a set of filtering strengths determined by using the neighbors' motion vectors, quantization parameters, reference index, and coded-block-patterns, etc. For entropy coding in entropy coding module 216, the motion vector differences (MVD), macroblock types, quantization parameter delta, inter predication type, etc. are required.

Consider the example where a particular macroblock MB (x, y) requires neighbor data from macroblocks MB (x−1, y−1), MB (x, y−1), MB (x+1, y−1) and MB (x−1, y). In prior art codecs, the preparation of the neighbor data needs to calculate the location of the relevant neighbor sub-blocks. However, the calculation is not as straightforward as it was in conventional video coding standards. For example, in H.264 coding, the support of multiple partition types make the size and shape for the subblocks vary significantly. Furthermore, the support of the macroblock adaptive frame and field (MBAFF) coding allows the macroblocks to be either in frame or in field mode. For each mode, one neighbor derivation method is defined in H.264. So the calculation needs to consider each mode accordingly. In addition, in order to get all of the neighbor data required, the derivation needs to be invoked four times since there are four neighbors involved—MB (x−1, y−1), MB (x, y−1), MB (x+1, y−1), and MB (x−1, y). So the encoding of the current macroblock MB (x, y) cannot start not until the location of the four neighbors has been determined and their data have been fetched from memory.

In an embodiment of the present invention, when each macroblock is processed and final motion vectors and encoded data are determined, neighbor data is stored in data structures for each neighboring macroblock that will need this data. Since the neighbor data is prepared in advance, the current macroblock MB (x, y) can start right away when it is ready to be processed. The burden of pinpointing neighbors is virtually re-allocated to its preceding macroblocks. The encoding of macroblocks can be therefore be more streamline and faster. In other words, when the final motion vectors are determined for MB (x−1, y−1), neighbor data is stored for each neighboring macroblock that is yet to be processed, including MB (x, y) and also other neighboring macroblocks such as MB (x, y−1), MB (x−2, y) MB (x−1, y). Similarly, when the final motion vectors are determined for MB (x, y−1), MB (x+1, y−1) and MB (x−1, y) neighbor data is stored for each neighboring macroblock corresponding to each of these macroblocks that are yet to be processed, including MB (x, y). In this fashion, when MB (x, y) is ready to be processed, the neighbor data is already stored in a data structure that corresponds to this macroblock for fast retrieval.

The motion compensation can then proceed using the retrieved data. In particular, the motion search module 204 and/or the motion refinement module, can generate at least one predicted motion vector (such as a standard PMV or estimated predicted motion vector) for each macroblock of the plurality of macroblocks using retrieved neighbor data. Further, the direct mode module 208 can generate at least one direct mode motion vector for each macroblock of the plurality of macroblocks using retrieved neighbor data and the intra-prediction module 210 can generate the best intra prediction mode for each macroblock of the plurality of macroblocks using retrieved neighbor data, and the coding module 216 can use retrieved neighbor data in entropy coding, each as set forth in the H.264 standard, the MPEG-4 standard, VC-1 (SMPTE standard 421M) or by other standard or other means.

Scene detection module 230 detects scene changes in the video signal 110 based, for example on motion detection in the video signal 110. In an embodiment of the present invention, scene detection module 230 generates a motion identification signal for each picture video signal 110. The motion in each picture, such as a video field (or frame if it is progressive-scan video source), can be represented by a parameter called Global Motion (GM). The value of GM quantifies the change of the field compared to the previous same-parity field. In terms of each macroblock pair, the top field is compared to the top field, bottom field compared to bottom field, etc. The value of GM can be computed as the sum of Pixel Motion (PM) over all pixels in the field or frame, where the value of PM is calculated for each pixel in the field or frame.

The parameter GM, can be used to detect a scene change in the video signal 110. When scene happens on a field, the field will generate considerably higher GM value compared to “normal” fields. A scene change can be detected by analyzing the GM pattern along consecutive fields, for example by detecting an increase or decrease in GM in consecutive fields that exceeds a scene detection threshold. Once a scene change is detected that corresponds to a particular image, encoding parameters of encoder/decoder 102 can be adjusted to achieve better results. For example, the detection of a scene change can be used to trigger the start of a new group of pictures (GOP). In another example, the encoder/decoder 102 responds to a scene change detection by adjusting the values of QP to compensate for the scene change, by enabling or disabling video filters or by adjusting or adapting other parameters of the encoding, decoding, transcoding or other processing by encoder/decoder 102.

While not expressly shown, video encoder/decoder 102 can include a memory cache, shared memory, a memory management module, a comb filter or other video filter, and/or other module to support the encoding of video signal 110 into processed video signal 112.

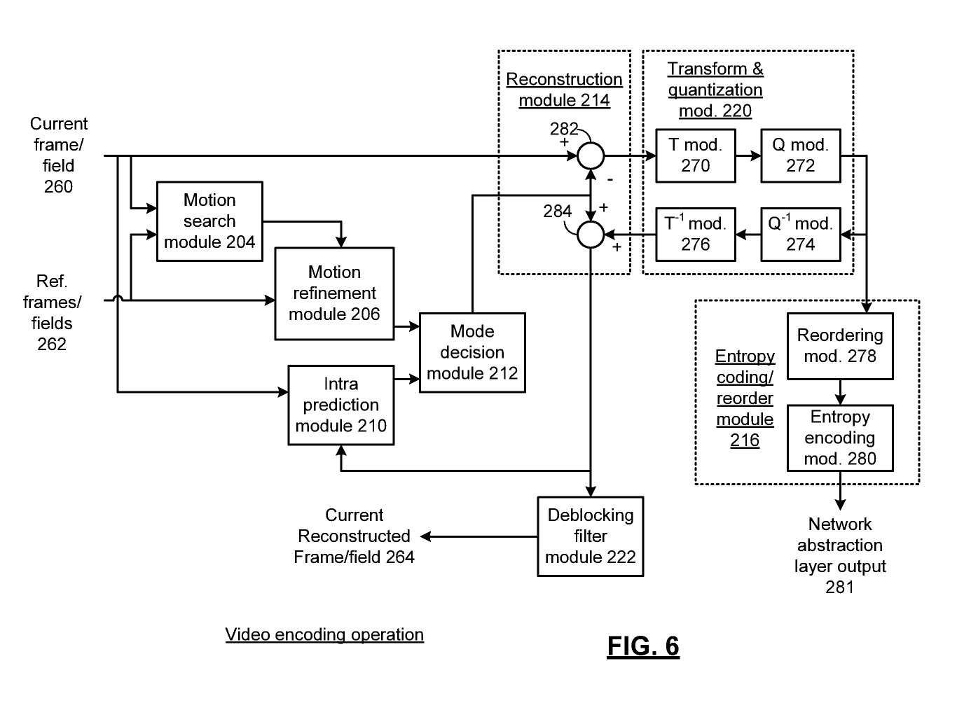

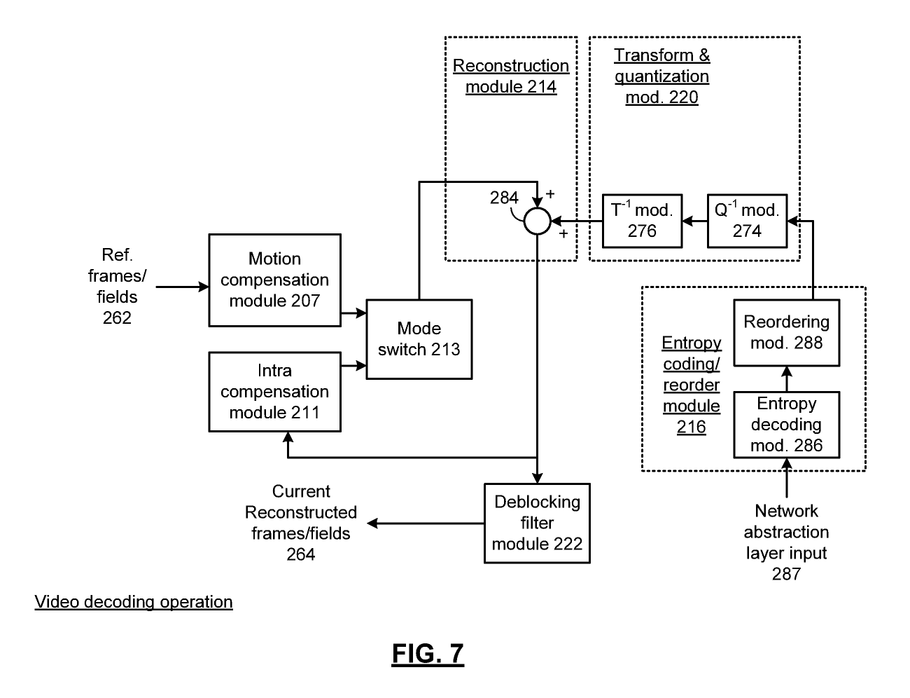

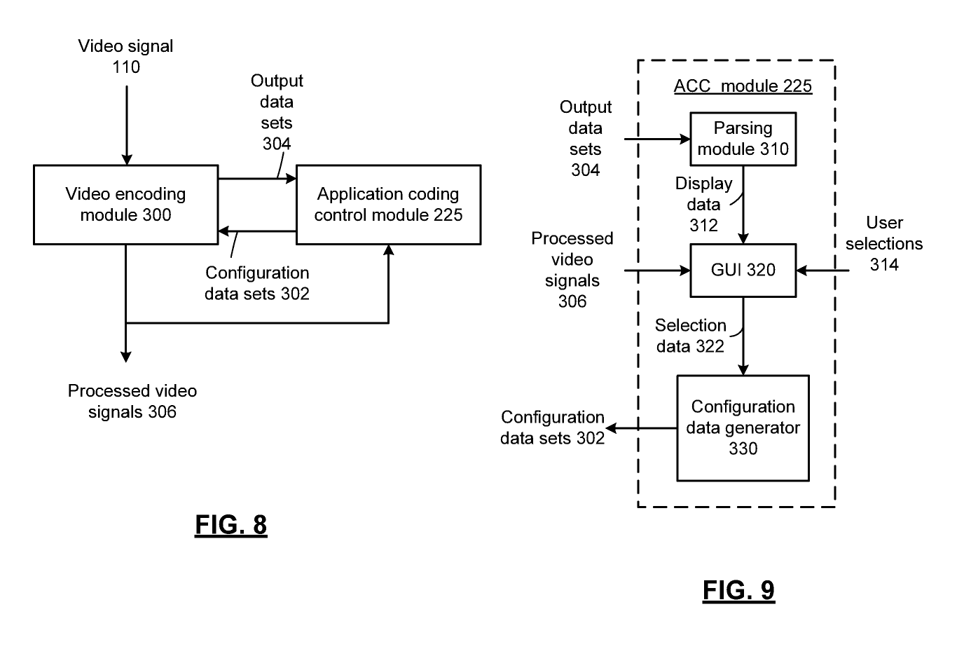

Further details of general encoding and decoding processes will be described in greater detail in conjunction with FIGS. 6 and 7. In addition, video encoder/decoder 102 includes application coding control module 225 that operates in conjunction with a multi-pass encoding process that will be described in greater detail in conjunction with FIGS. 8-14.

FIG. 6 presents a block flow diagram of a video encoding operation in accordance with an embodiment of the present invention. In particular, an example video encoding operation is shown that uses many of the function specific modules described in conjunction with FIG. 5 to implement a similar encoding operation. Motion search module 204 generates a motion search motion vector for each macroblock of a plurality of macroblocks based on a current frame/field 260 and one or more reference frames/fields 262. Motion refinement module 206 generates a refined motion vector for each macroblock of the plurality of macroblocks, based on the motion search motion vector. Intra-prediction module 210 evaluates and chooses a best intra prediction mode for each macroblock of the plurality of macroblocks. Mode decision module 212 determines a final motion vector for each macroblock of the plurality of macroblocks based on costs associated with the refined motion vector, and the best intra prediction mode.

Reconstruction module 214 generates residual pixel values corresponding to the final motion vector for each macroblock of the plurality of macroblocks by subtraction from the pixel values of the current frame/field 260 by difference circuit 282 and generates unfiltered reconstructed frames/fields by re-adding residual pixel values (processed through transform and quantization module 220) using adding circuit 284. The transform and quantization module 220 transforms and quantizes the residual pixel values in transform module 270 and quantization module 272 and re-forms residual pixel values by inverse transforming and dequantization in inverse transform module 276 and dequantization module 274. In addition, the quantized and transformed residual pixel values are reordered by reordering module 278 and entropy encoded by entropy encoding module 280 of entropy coding/reordering module 216 to form network abstraction layer output 281.

Deblocking filter module 222 forms the current reconstructed frames/fields 264 from the unfiltered reconstructed frames/fields. It should also be noted that current reconstructed frames/fields 264 can be buffered to generate reference frames/fields 262 for future current frames/fields 260.

As discussed in conjunction with FIG. 5, one or more of the modules of video encoder/decoder 102 can also be used in the decoding process as will be described further in conjunction with FIG. 7.

FIG. 7 presents a block flow diagram of a video decoding operation in accordance with an embodiment of the present invention. In particular, this video decoding operation contains many common elements described in conjunction with FIG. 6 that are referred to by common reference numerals. In this case, the motion compensation module 207, the intra-compensation module 211, the mode switch 213, process reference frames/fields 262 to generate current reconstructed frames/fields 264. In addition, the reconstruction module 214 reuses the adding circuit 284 and the transform and quantization module reuses the inverse transform module 276 and the inverse quantization module 274. It should be noted that while entropy coding/reorder module 216 is reused, instead of reordering module 278 and entropy encoding module 280 producing the network abstraction layer output 281, network abstraction layer input 287 is processed by entropy decoding module 286 and reordering module 288.

While the reuse of modules, such as particular function specific hardware engines, has been described in conjunction with the specific encoding and decoding operations of FIGS. 6 and 7, the present invention can likewise be similarly employed to the other embodiments of the present invention described in conjunction with FIGS. 1-5 and 8-14 and/or with other function specific modules used in conjunction with video encoding and decoding. In particular, while FIG. 6 describes a single pass encoding process, FIGS. 8-14 describe the use of the encoding portion of encoder/decoder 102 in conjunction with a multi-pass encoding of video signal 110 controlled by application coding control module 225.

FIG. 8 presents a block diagram representation of a video encoder in accordance with an embodiment of the present invention. In particular a multi-pass video encoder is shown that includes a single pass video encoding module 300 that can be implemented via the encoding components of video encoder/decoder 102, an XCODE processing device made available from VIXS Systems, Inc. or other single pass video encoder. The single pass video encoding module is controlled by application coding control module 225 to iteratively encode video signal 110 into processed video signals 306 through multiple passes. In general, application coding control module 225 generates successive configuration data sets 302 to specify one or more encoding parameters to be used by the video encoding module 300 in each iterative encoding of the video signal 110. In an embodiment of the present invention, the application coding control module 225 can be implemented using a single processing device or a plurality of processing devices that, at each iteration, analyze the output data set 304 and the processed video signal 306 in order to automatically generate the next configuration data set 302. In the alternative, as will be discussed further in conjunction with FIG. 9, the application coding control module 225 operates based on user selections to select successive configuration data sets 302.

In a first pass, the video encoding module 300 encodes the video signal 110 based on an initial configuration data set 302 generated by application control module 225. The video encoding module 300 generates the encoded video signal as an initial processed video signal 306. In addition, the video encoding module generates an initial output data set 304 that includes data that indicates parameters of the actual video encoding. The application coding control module 225 analyzes both the initial processed video signal 306 and the initial output data set 304 and, in response, generates a first updated configuration data set 302.

In a second pass, the video encoding module 300 encodes the video signal 110 again based on the first updated configuration data set 302 to generate a first updated processed video signal 306 and a first updated output data set 304. The process can continue by the application coding control module 225 generating a second updated configuration data set 302 based on both the first updated processed video signal 306 and the first updated output data set 304. A third pass can be performed by the video encoding module 300 encoding the video signal 110 based on the second updated configuration data set 302 to generate a second updated processed video signal 306 and a second updated output data set 304.

In this fashion, the video encoding module 300 and application coding control module 225 cooperate to iteratively refine the encoding of video signal 110 into a processed video signal 306 over 2, 3, 4, 5 or a greater number of iterations. It should be noted that previous versions of the processed video signals 306, configuration data sets 302, and output data sets 304 can be buffered in memory such as memory module 202, and discarded either after each new iteration or after the final iteration. In particular, the processed video signal 306 generated by the final iteration or selected from the previous processed video signals after the final iteration can be output as the processed video signal 112.

The operation of video encoding module 300 and application coding control module 225 can be described in conjunction with the following examples. The initial configuration data set 302 can, for instance, control the first pass encoding/transcoding of video signal 110 to collect stream information. Assuming the details of the video signal 110 (picture numbers, resolution, etc.) may not be available, the initial configuration data set 302 may only specify stream level coding control parameters. In one example, the application coding control module 225 specifies a GOP structure, and a picture level Qp for I, P and B picture. In this case, the video encoding module 300 may start a new GOP based on scene change detection result from scene change detection module 230 while following the GOP size restriction specified by the initial configuration data set 302. The video encoding module 300 can assign individual MB Qp (offset to the picture level Qp), based on MB statistical information such as variance and/or motion.

In another example, the application coding control module 225 can give the video encoding module 300 more freedom to control the encoding process. Instead of specifying picture level Qp for each picture type (I, P or B), the application coding control module 225 may only specify a baseline Qp for the stream. In response, the video encoding module 300 can adaptively assign picture level Qp to different picture types based on characteristics of the stream to be coded.

As discussed above, the video encoding module 300 generates successive output data sets 304 in conjunction with each encoding of the video signal 110. For example, the video encoding module 300 can stream output data at the same time that it is outputting the processed video signal 306. The output data set can be provided through a data structure for each picture of the processed video signal 306. All pictures in the stream will have a corresponding data structure in the output information data file that indicate parameters used in the encoding of each picture, along with optionally other statistics and metrics. For example, an output data set 304 can include picture level Qp, picture level motion information, picture level variance information, etc. Based on the desired size of the output data set 304, MB level information may or may not be included.

After the first iteration, an analysis of the initial output data set 304 and the initial processed video signal 306 can provide the application coding control module 225 with greater information that can be used to refine later pass codings. Later-pass configuration data sets 302 can be provided by the application coding control module 225 to specify coding parameters for each picture of the stream, such as AVC coding parameters or condign parameters associated with other encoding methodologies. For example, the configuration data sets can include picture level coding control parameters such as picture level Qp, picture type (I, P and B), and other coding parameters. In an embodiment of the present invention, the configuration data sets 302 and the output data sets 304 can have similar data structures and include similar information.

While described above primarily in terms of an encoding of a video signal 110, these techniques can similarly be applied to a transcoding of the a video signal 110 into a processed video signal 112 having a different video compression format, scale, resolution, frame rate or other format. It should be noted that the multi-pass operation of this encoding system allows the non-realtime encoding/transcoding application to achieve, offline, better rate control and picture quality. Rate control functionality can be solely performed by application coding control module 225, based on appropriate selection of the configuration data sets 302.

FIG. 9 presents a block diagram representation of an application coding control module 225 in accordance with an embodiment of the present invention. In this embodiment, the application coding control module 225 operates based on user selections 314 to select successive configuration data set 302. In particular, the application coding control module 225 includes a parsing module 310 that generates display data 312 from the initial and subsequent output data sets 304 for display. A graphical user interface 320 displays the display data 312 and at least a portion of the initial processed video signal 306, in a split screen format, for example, to allow a user to gage the quality of the encoded video, spot encoding artifacts and the potential problems. The graphical user interface 320 allows the user to input user selections 314 such as updated coding parameters, etc, that are to transferred as selection data 322 and used by configuration data generator 330 to generate updated configuration data sets 302.

In operation, the application coding control module 225 generates configuration data 302 to configure the video encoding module 300 for the first-pass (e.g. best effort) encoding. The application coding control module 225 allows the user to analyze the processed video signal 306 and the output data sets 304. The application coding control module can provide an easy interface for the user to change the coding parameters and automatically generate configuration data sets 302 for the configuration of later-pass encoding via the video encoding module 300.

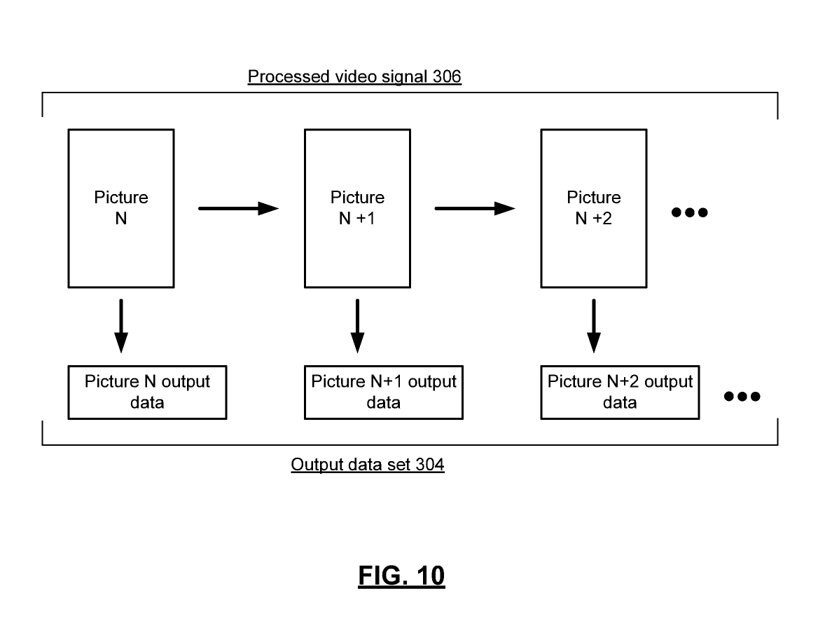

FIG. 10 presents a graphical representation of processed video signal 306 in accordance with an embodiment of the present invention. As shown, each processed video signal 306 (initial or later-pass) includes a plurality of pictures [N, N+1, N+2, . . . ] such as frames or fields of the video stream. The output data sets 304 generated in conjunction with the processed video signal 306 (initial or later-pass) includes separate output data for each picture [picture N output data, picture N+1 output data, picture N+2 output data, . . . ]. All pictures in the stream will have a corresponding data structure in the output information data file that indicate, for instance, parameters used in the encoding of each picture, along with optionally other statistics and metrics. In the example discussed in conjunction with FIG. 8, the output data set 304 can include picture level Qp, picture level motion information, picture level variance information, etc. Based on the desired size of the output data set 304, MB level information may or may not be included.

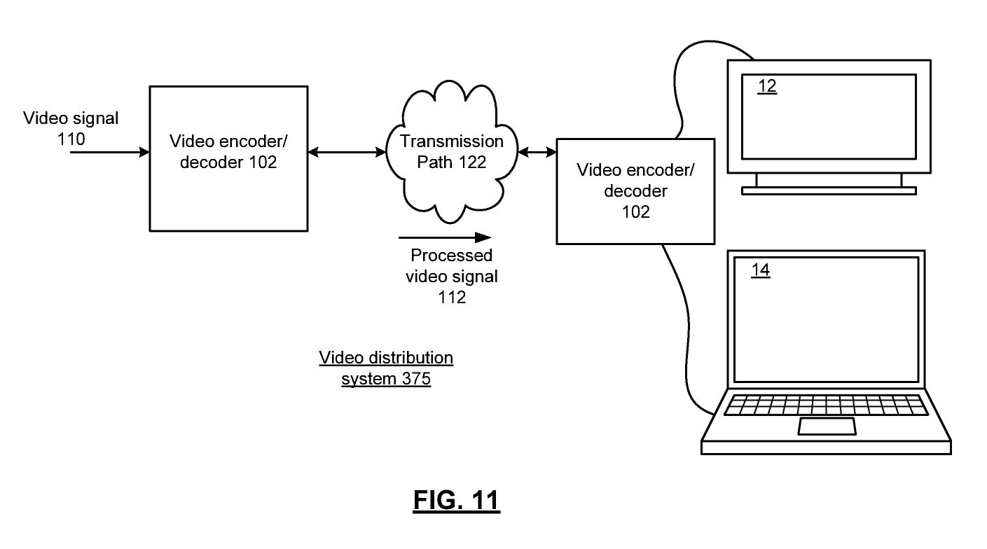

FIG. 11 presents a block diagram representation of a video distribution system 375 in accordance with an embodiment of the present invention. In particular, processed video signal 112 is transmitted from a first video encoder/decoder 102 via a transmission path 122 to a second video encoder/decoder 102 that operates as a decoder. The second video encoder/decoder 102 operates to decode the processed video signal 112 for display on a display device such as television 12, computer 14 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a Universal Serial Bus protocol, an Ethernet protocol or other high speed protocol.

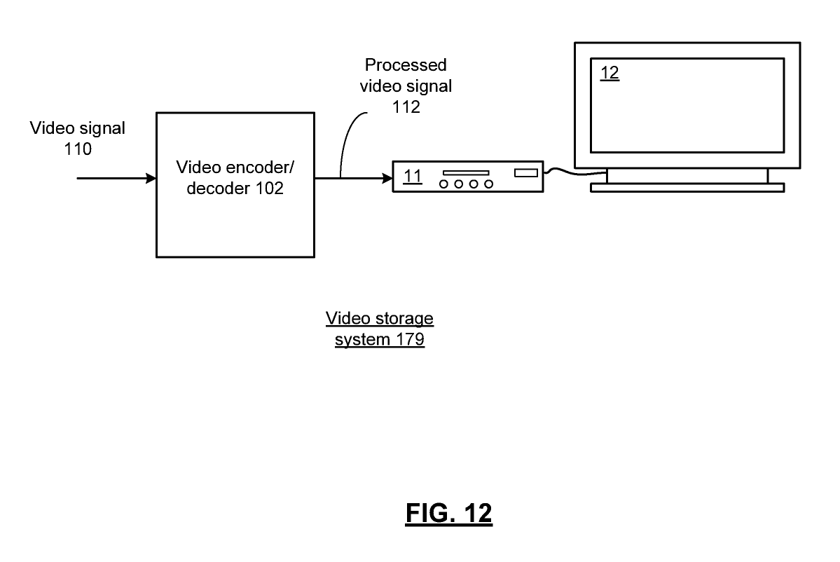

FIG. 12 presents a block diagram representation of a video storage system 179 in accordance with an embodiment of the present invention. In particular, device 11 is a set top box with built-in digital video recorder functionality, a stand alone digital video recorder, a DVD recorder/player or other device that stores the processed video signal 112 for display on video display device such as television 12. While video encoder/decoder 102 is shown as a separate device, it can further be incorporated into device 11. In this configuration, video encoder/decoder 102 can further operate to decode the processed video signal 112 when retrieved from storage to generate a video signal in a format that is suitable for display by video display device 12. While these particular devices are illustrated, video storage system 179 can include a hard drive, flash memory device, computer, DVD burner, or any other device that is capable of generating, storing, decoding and/or displaying the video content of processed video signal 112 in accordance with the methods and systems described in conjunction with the features and functions of the present invention as described herein.

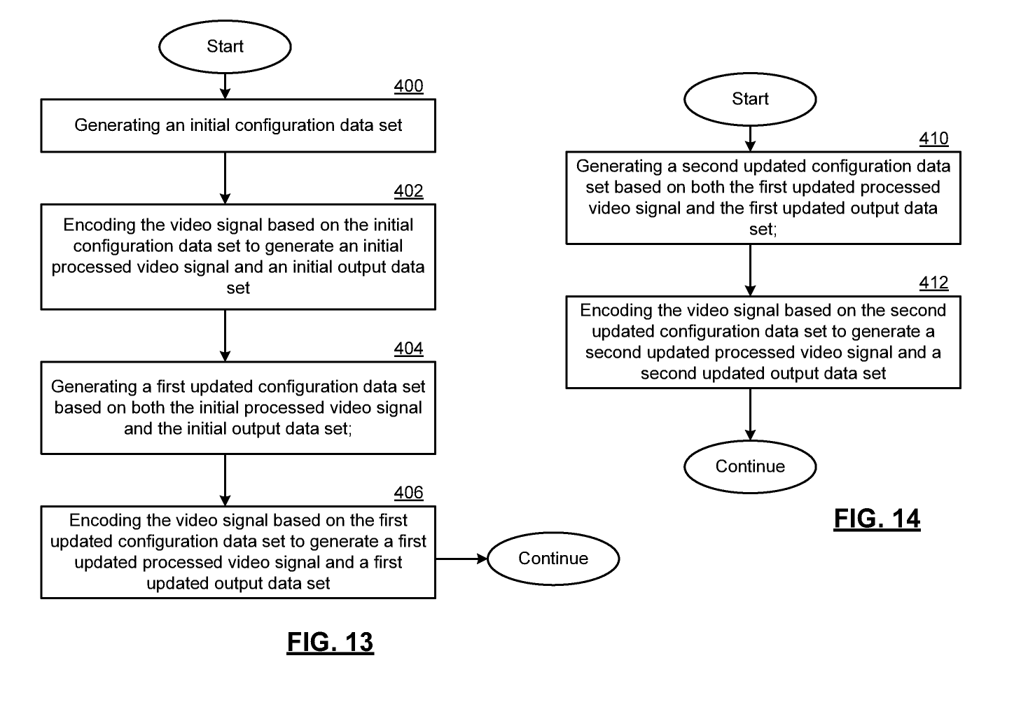

FIG. 13 presents a flowchart representation of a method in accordance with an embodiment of the present invention. In particular, a method is presented for use in conjunction with a video processing device having one or more of the features and functions described in association with FIGS. 1-12. In step 400 an initial configuration data set is generated. In step 402, a video signal is encoded based on the initial configuration data set to generate an initial processed video signal and an initial output data set. In step 404, a first updated configuration data set is generated based on both the initial processed video signal and the initial output data set. In step 406, the video signal is encoded based on the first updated configuration data set to generate a first updated processed video signal and a first updated output data set.

The initial configuration data set can indicate: a group of picture structure for a plurality of pictures of the initial processed video signal; a picture level quantization parameter for I, P and B pictures in the plurality of pictures of the initial processed video signal; and/or a baseline quantization parameter. The initial output data set can include separate initial output data for each of an initial plurality of pictures of the initial processed video signal. Likewise, the first updated output data set can include separate first updated output data for each of a first updated plurality of pictures of the first updated processed video signal. The initial output data set can include: at least one picture level quantization parameter for a plurality of pictures of the initial processed video signal; at least one picture level motion parameter for a plurality of pictures of the initial processed video signal; and at least one picture level variance for a plurality of pictures of the initial processed video signal.

Step 404 can include: generating display data from the initial output data set; displaying the display data and at least a portion of the initial processed video signal; generating selection data in response to user selections; and/or generating the first updated configuration data, based on the selection data.

FIG. 14 presents a flowchart representation of a method in accordance with an embodiment of the present invention. In particular, a method is presented for use in conjunction with a video processing device having one or more of the features and functions described in association with FIGS. 1-13. In step 410 a second updated configuration data set is generated based on both the first updated processed video signal and the first updated output data set. In step 412, the video signal is encoded based on the second updated configuration data set to generate a second updated processed video signal and a second updated output data set.

While particular combinations of various functions and features of the present invention have been expressly described herein, other combinations of these features and functions are possible that are not limited by the particular examples disclosed herein are expressly incorporated in within the scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a video processing device, a video encoder/decoder and multi-pass encoder for use therewith. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A multi-pass video encoder for use in a video processing device that processes a video signal, the multi-pass video encoder comprising:
a video encoding module, that encodes the video signal based on an initial configuration data set to generate an initial processed video signal and an initial output data set; and
an application coding control module, coupled to the video encoding module, that generates the initial configuration data set and that generates a first updated configuration data set based on both the initial processed video signal and the initial output data set;
wherein the video encoding module further encodes the video signal based on the first updated configuration data set to generate a first updated processed video signal and a first updated output data set.

2. The multi-pass video encoder of claim 1 wherein the application coding control module generates a second updated configuration data set based on both the first updated processed video signal and the first updated output data set; and
wherein the video encoding module further encodes the video signal based on the second updated configuration data set to generate a second updated processed video signal and a second updated output data set.

3. The multi-pass video encoder of claim 1 wherein the initial configuration data set indicates at least one of:
a group of picture structure for a plurality of pictures of the initial processed video signal;
a picture level quantization parameter for I, P and B pictures in the plurality of pictures of the initial processed video signal; and
a baseline quantization parameter.

4. The multi-pass video encoder of claim 1 wherein the initial output data set includes separate initial output data for each of an initial plurality of pictures of the initial processed video signal, and wherein the first updated output data set includes separate first updated output data for each of a first updated plurality of pictures of the first updated processed video signal.

5. The multi-pass video encoder of claim 1 wherein the initial output data set includes at least one of:
at least one picture level quantization parameter for a plurality of pictures of the initial processed video signal;
at least one picture level motion parameter for the plurality of pictures of the initial processed video signal; and
at least one picture level variance for the plurality of pictures of the initial processed video signal.

6. The multi-pass video encoder of claim 1 wherein the application coding control module includes:
a parsing module that generates display data from the initial output data set;
a graphical user interface, coupled to the parsing module, that:
displays the display data and at least a portion of the initial processed video signal; and
generates selection data in response to user selections; and
a configuration data generation module, coupled to the graphical user interface, that generates the first updated configuration data set, based on the selection data.

7. A method for use in a video processing device that processes a video signal, the method comprising:
generating an initial configuration data set;
encoding the video signal based on the initial configuration data set to generate an initial processed video signal and an initial output data set;
generating a first updated configuration data set based on both the initial processed video signal and the initial output data set; and
encoding the video signal based on the first updated configuration data set to generate a first updated processed video signal and a first updated output data set.

8. The method of claim 7 further comprising:
generates a second updated configuration data set based on both the first updated processed video signal and the first updated output data set; and
encoding the video signal based on the second updated configuration data set to generate a second updated processed video signal and a second updated output data set.

9. The method of claim 7 wherein the initial configuration data set indicates at least one of:
a group of picture structure for a plurality of pictures of the initial processed video signal;
a picture level quantization parameter for I, P and B pictures in the plurality of pictures of the initial processed video signal; and
a baseline quantization parameter.

10. The method of claim 7 wherein the initial output data set includes separate initial output data for each of an initial plurality of pictures of the initial processed video signal, and wherein the first updated output data set includes separate first updated output data for each of a first updated plurality of pictures of the first updated processed video signal.

11. The method of claim 7 wherein the initial output data set includes at least one of:
at least one picture level quantization parameter for a plurality of pictures of the initial processed video signal;
at least one picture level motion parameter for the plurality of pictures of the initial processed video signal; and
at least one picture level variance for the plurality of pictures of the initial processed video signal.

12. The method of claim 7 wherein generating the first updated configuration data set includes:
generates display data from the initial output data set;
displaying the display data and at least a portion of the initial processed video signal;
generating selection data in response to user selections; and
generating the first updated configuration data set, based on the selection data.
